(19) United States
(12) Patent Application Publication
(10) Pub. No.: US 2017/0221093 A1
(43) Pub. Date: Aug. 3, 2017

(54) Dynamically Generating Video / Animation, in Real-Time, in a Display or Electronic Advertisement Based on User Data

(71) Applicant: GOOGLE INC., Mountain View, CA (US)

(72) Inventor: Aman Govil, San Francisco, CA (US)

(21) Appl. No.: 13/707,322

(22) Filed: Dec. 6, 2012

Related U.S. Application Data
(60) Provisional application No. 61/568,102, filed on Dec. 7, 2011.

(51) Int. Cl. G06Q 30/02

(52) U.S. Cl. CPC G06Q 30/0251

(57) ABSTRACT

Methods, systems and computer-readable storage mediums encoded with computer programs executed by one or more processors for generating dynamic content in real-time are disclosed. In an embodiment, a static portion of an electronic advertisement is provided for display on a user device. Input is received from the user device, and a dynamic portion of the advertisement is generated in real-time. The dynamic portion of the advertisement is provided for display on a user device.

### CROSS-REFERENCE TO RELATED APPLICATION

This application claims the benefit of U.S. Provisional Application No. 61/568,102, filed Dec. 7, 2011, which is hereby incorporated by reference in its entirety.

### TECHNICAL FIELD

Embodiments herein relate generally to dynamically generating video or animations in real-time.

### BACKGROUND

Currently videos in advertisements are pre-rendered. When they are displayed, a conventional advertising system only chooses which pre-rendered video to show based on user input or targeting signals from the ad server. This limits the number of videos an advertising system can serve, and an advertiser's ability to customize each advertisement for a consumer.

### BRIEF DESCRIPTION OF THE FIGURES

Embodiments are described with reference to the accompanying drawings. In the drawings, like reference numbers may indicate identical or functionally similar elements. The drawing in which an element first appears is generally indicated by the left-most digit in the corresponding reference number.

FIG. 1 is a block diagram illustrating an example system for dynamically generating video/animation, in real-time, in a display or electronic advertisement based on user data, according to an embodiment.

FIG. 2 is a method for dynamically generating video/animation, in real-time, in a display or electronic advertisement based on user data, according to an embodiment.

FIG. 3 is a block diagram 300 that illustrates components that may go into generating an exemplary video/animation in real time, according to an embodiment.

FIG. 4 illustrates an example embodiment of using the method of FIG. 2.

FIG. 5 is a diagram illustrating an example usage of a system for dynamically generating a display or electronic advertisement based on user data, according to an embodiment.

FIG. 6 is a diagram illustrating another example usage of the system for dynamically generating video/animation, in real-time, in a display or electronic advertisement based on user data, according to another embodiment.

FIG. 7 is a block diagram of an example environment in which an advertisement system manages advertising services, according to an embodiment.

FIG. 8 is a system diagram that can be used to implement embodiments described herein.

### DETAILED DESCRIPTION

Embodiments are described herein with reference to illustrations for particular applications. It should be understood that the embodiments are not intended to be limiting. Those skilled in the art with access to the teachings provided herein will recognize additional modifications, applications, and embodiments within the scope thereof and additional fields in which the embodiments would be of significant utility.

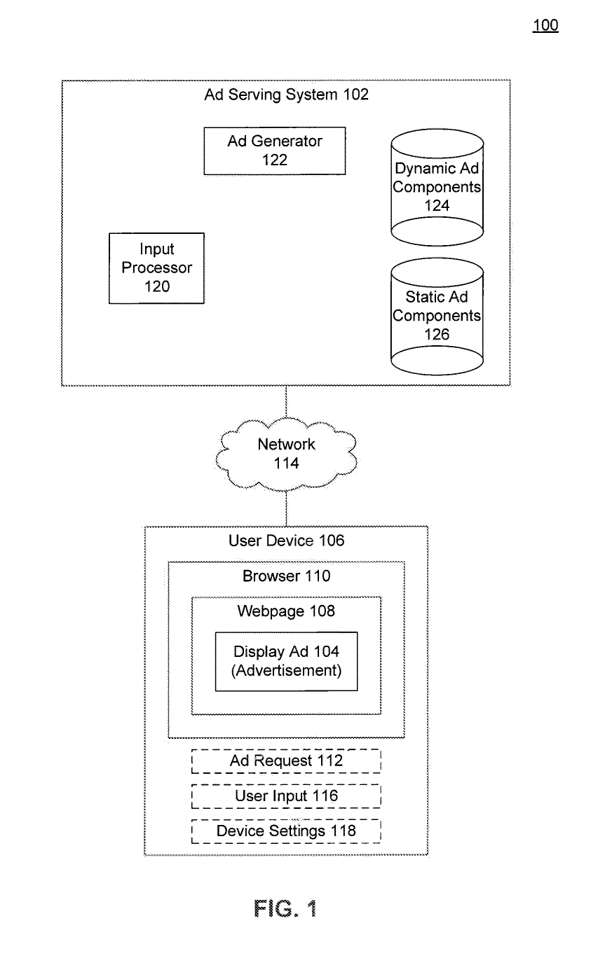

FIG. 1 is a block diagram illustrating an example system 100 for dynamically generating video/animation, in real-time, in a display or electronic advertisement based on user data. System 100 includes an ad serving system 102 that provides display ads 104 for display on a user device 106. Display ad 104 may include any electronic advertisement, commercial or other marketing product that is displayed on user device 106. As used herein, the terms advertisement 104 and display ad 104 are used interchangeably to refer to the same feature. User device 106 may include any computing device, including but not limited to a computer, tablet computer, mobile phone, television or other device that has a screen that can render display ad 104.

In an embodiment, display ad 104 may appear on a webpage 108 within a browser 110 operating on user device 106. For example, a user may start an instance of a web browser 110 on user device 106 and enter the address of or otherwise navigate to webpage 108. Webpage 108 may be enabled to display or render one or more electronic advertisements 104. In another embodiment, the display ad 104 may appear on an app, such as a mobile app, operating on a mobile phone or other mobile computing device.

Webpage 108 (or a server or system hosting webpage 108) may, in response to the user navigating to webpage 108, send an ad request 112 to ad serving system 102 for one or more electronic advertisements 104 that are to be rendered on webpage 108. Ad request 112 may include information about the computing environment or device settings 118 of user device 106, such as the device type, the type of browser, browsing history, location, etc. Ad request 112 may also include information requested or queried from a user or operator of user device 106.

Ad serving system 102 may then send back display ad 104 for rendering on or with webpage 108. In an embodiment, ad serving system 102 may send display ad 104 to the server hosting webpage 108. Then, when webpage 108 is retrieved or requested from the server, advertisement 104 is rendered with webpage 108. In another embodiment, ad serving system 102 may send display ad 104 directly to user device 106 for rendering with webpage 108. The user would then see the content of display ad 104 as received from ad serving system 102 and webpage 108 (which may be received from ad serving system 102 or a separate webpage server) in response to navigating to webpage 108, or otherwise triggering ad request 112.

User device 106 may communicate with ad serving system 102 over a network 114. Network 114 may include any communications network including wired, or wireless communications, such as an intranet, a mobile phone network, or the Internet. For example, user device 106 may be a mobile phone that retrieves web page data (for webpage 108), including the display ad 104, from one or more servers over the Internet (e.g., network 114). Or, for example, user device 106 may access an app that communicates over network 114 and retrieves or receives display ad 104.

Display ad 104 may be an interactive or dynamically generated advertisement that is generated based on user input 116 and/or device settings 118 as determined from user device 106. User input 116 could be any input, as provided by a user, in response to a request for input by display ad 104. For example, display ad 104 may query a user for his/her name, or preference with regards to a particular matter. The user's response may be received as user input 116 and provided to ad serving system 102. This query may occur before display ad 104 is rendered and/or as part of the operation of display ad 104. Additionally or alternatively, device settings 118 of user device 106 may be captured and provided to ad serving system 102.

Device settings 118 may be any settings of user device 106, including, but not limited to, which webpage 108 a user is viewing, which browser 110 is being used, the time, the date, the type of device 106 (e.g., laptop, tablet or mobile phone), any technical specifications of device 106, browsing and/or purchase history of a user, device 106 location or other information that may be electronically queried from or about user device 106. In an embodiment, this information may be provided to ad serving system 102 in ad request 112.

An input processor 120 may receive ad request 112 and user input 116, and provide this information to an ad generator 122 that may provide and/or generate portions of one or more advertisements 104. Ad generator 122 may dynamically generate advertisements 104 based on ad request 112 and user input 116. The ad generation (as performed by ad generator 122) may occur prior to and/or during the execution of portions of display ad 104. For example, display ad 104 may play an introductory portion of video based on device settings 118, and may query a user for a selection or other data. Then, based on a response as provided via user device 106, as queried during the execution of display ad 104, ad generator 122 may generate another portion or a remainder of display ad 104.

Display ad 104 may be dynamically generated and may include both static ad components 126 that are included in different iterations of display ad 104, and dynamic ad components 124 that may change based on device settings 118 and/or user input 116. Static ad components 126 may include, for example, an introduction to advertisement 104, or a company logo or tagline that is displayed at the end of advertisement 104. Dynamic ad components 134, by contrast, may include components of advertisement 104 that may be variable based on device settings 118 and/or user input 116. For example, the introduction of advertisement 104 may vary based on a user's location. Ad generator 122 may receive device settings 118, including GPS coordinates or other location information of user device 106 to select which introduction to play as part of advertisement 104. This dynamic ad component 124, for example, may include scenic shots of a major city that is closest to the user's location.

Advertisement 104 may then play for a period of time, and a request may be provided to the user to select or enter some input, such as, a desired destination for a vacation. Ad generator 122 may receive this user input 116 and generate another portion of advertisement 104 and/or select/generate a dynamic ad component 124 for advertisement 104 based on the user's selection. Advertisement 104 may then include dynamically generated imagery of the selected destination (e.g., dynamic ad component 124), which may be merged with a static ad component 126, such as a company logo or tag line that is displayed with every advertisement 104 for a particular advertiser.

In another embodiment, display ad 104 may feature a person looking at a touchscreen computer. Ad generator 122 may dynamically determine and generate what image/video (e.g., dynamic ad component 124) is displayed on the touchscreen computer. For example, ad generator 122 may determine as part of the information received with ad request 112, which website or webpage 108 a user is viewing on user device 106. Ad generator 122 may then capture or receive a screenshot of the website (e.g., webpage 108) that the user is viewing and overlay the screen of the touchscreen computer within display ad 104 with the captured/received screenshot.

In another example, ad generator 122 may determine a user's location (e.g., location of user device 106). Ad generator 122 may then determine the current weather at the user's location. Based on the current weather, ad generator 122 may then select a corresponding dynamic ad component 124 based on the weather. For example, advertisement 104 may have several scenes, each taped with different weather conditions (e.g., sunny, snowing, raining). If ad generator 122 determines it is snowing at the user's location, ad generator 122 may select the footage of advertisement 104 that was shot in the snow.

In another example, advertisement 104 may include a telephone number that is displayed while advertisement 104, or a portion thereof, is played (on user device 106). If a user then sends a text or SMS message to the telephone number, the text message, as received from the user, may then be displayed in advertisement 104 by ad generator 122. Or, for example, advertisement 104 may show a coupon that an actor is holding, or that is sitting on a table. Then, a user viewing advertisement 104 may be able to retrieve the coupon from the company's website, mobile app, or by texting into a particular number.

In another embodiment, actors from advertisement 104 may react to user input or cues. For example, if a viewer dials a telephone number, then an actor may hear the phone ring simultaneously and may go to answer the phone. Ad generator 122, may for example, receive the cue of the call, and generate or select the footage of a phone call. Or, for example, a viewer may select a radio station that plays in advertisement 104. In another embodiment, a viewer may play an interactive game that is shown on advertisement 104, For example, using a mobile device's accelerometer, a viewer may have to keep a particular product balanced while an actor is driving in a car in advertisement 104. Other examples, may allow a viewer to choose alternate endings or sequences for characters and/or storylines of advertisement 104.

In another embodiment, ad generator 122 may display advertisement 104 that corresponds with the time of day of where a viewer is located. For example, in the morning a first portion of advertisement 104 may play, in which the storyline occurs in the morning. If the user checks advertisement 104 later in the evening, ad generator 122 may generate dynamic ad components 124 corresponding to evening time for the story line.

In another example embodiment, a live television or web broadcast may be displayed in advertisement 104. For example, ad generator 122 may overlay a blank television screen appearing in advertisement 104 with an ongoing sporting event as captured from a live stream. Or, for example, advertisement 104 may include an info-graphic, such as a pie chart that captures live data about a particular subject. For example, an info-graphic may be a pie chart of popular social network posts or search queries at any given time. In later iterations of advertisement 104, the subject matter of the info-graphic may change.

In another embodiment, ad generator 122 may select one or more dynamic ad components 124 where a viewer becomes a character in the story. For example, based on a viewer's input the characters in advertisement 104 may react differently or have different lines to say, as may be generated or selected by ad generator 122.

Ad serving system 102 can request, determine and process user input 116 and device settings 118 to dynamically, and in real-time, generate advertisements 104 tailored to and responsive to a user Who is viewing advertisement 104. Such tailored or customised advertisements 104, particular to the user and his/her environment, are likely to have greater appeal to the user and make the user more responsive to advertisements 104. Ad serving system 102 allows an advertiser to develop a concept for a particular advertisement 104 that may be rendered in any number of different combinations, which may be determined dynamically, based on the user input 116 and/or device settings 118.

In another embodiment, ad serving system 102 may generate advertisements using pre-recorded videos, portions of which may be selected and/or modified, based on the information of a particular user. For example, in an advertisement 104 for a clothing store, an advertiser may provide several options for clothing to be featured based on a user's location. The clothing to be featured may include swimwear if advertisement 104 is being displayed on a device 106 in location where the weather is greater than or equal to 60 degrees Fahrenheit, and winter clothing if advertisement 104 is being shown where the current temperature (at the determined location of device 106) is less than 60 degrees. Input processor 120 may determine the user's location (e.g., either based on ad request 112 or by querying the user or user device 106) and determine the weather conditions (e.g., by querying another web service or website) and ad generator 122 may select the corresponding advertisement 104 (or portion thereof) for display.

Ad serving system 102 allows an advertiser to make/display a mobile or electronic advertisement 104 where the video content is dynamically generated in real time based on any number of factors associated with a user who is viewing the advertisement 104 on a user device 106. The advertiser may provide static ad components that are displayed or run with every execution of advertisement 104, and one or more dynamic components that may vary based on the dynamically determined user input 116 and/or device settings 118.

Ad serving system 102 may programmatically generate animation or video, in a display ad or mobile ad 104, based on a user's data (such as geographic or physical location data, user device 106 data, or other data queried, received or otherwise determined about the user), as known to ad generator 122 from the ad request 112, and any user input 116 received from the user while interacting with display ad 104. Ad serving system 102 allows each user to see an advertisement 104 with customized video and/or other content that is dynamically generated in real time. The content of advertisement 104 is tailored for that specific ad impression and interaction. This dynamically generated animation/video can also be programmatically combined, composited or overlaid with any pre-rendered video, images, text or audio content. The dynamic portion of the content in any video (dynamic ad component 124), that is controlled by the gathered or received data, can be automated based on data available to ad serving system 102 (without user input 116), or could be influenced by user interactions and input 116.

In an embodiment, when a user operating web browser 110 enters the address, selects a link to view, or otherwise navigates to a webpage 108 that is enabled to present dynamically generated ads, webpage 108 (or server or other machine hosting webpage 108) may gather electronically determinable information about the user and/or the user's computing environment (e.g., device settings 118). Device settings 118 may include an identification of the web page 108 the user is requesting/viewing, the type of device (e.g., 106) the user is operating, a user name, user location or IP address, GPS coordinates of the user (or user device 106), the type of web browser 110 the user is operating, and provide at least some of this information with ad request 112.

Ad serving system 102, upon receiving ad request 112 with the collected user information and device settings 118, may then provide at least a portion of a dynamically generated advertisement 104 to webpage 108 or user device 106 for display. Additional information (e.g., user input 116) may be queried from the user as the user is watching advertisement 104, or otherwise as advertisement 104 is running on user device 106.

In an embodiment, ad serving system 102 can change any elements of an animation in a display ad 104 based on user input 116 or automated signals. Ad serving system 102 may, for example, perform a text overlay in advertisement 104 on top of a video. The overlay may include audio or video. Ad serving system 102 can also create a video in real time, rather than combining multiple, existing content elements or components (124, 126) in a single display ad 104. Ad serving system 102 can generate production quality videos, that the display advertising industry has been doing with programmatic animation (typically in flash or html5). The video content generated by ad serving system 102 may be the whole advertisement 104, or a part of advertisement 104. Conventional systems may select from any number of possible combination of images, text, videos to build a display ad programmatically. However the video content of conventional systems is not generated dynamically, as is done by ad serving system 102.

Also, another example of conventional systems is for an advertiser to pre-render as many combinations of videos/images/text that the advertiser thinks could possibly exist. Then, a conventional advertisement serving platform will pick one of the pre-rendered combinations and show it in the advertisement. This, however, is not real-time video/animation generation, rather it is the mere selection of pre-rendered video.

Ad serving system 102 may use contextual and audience signals or cues in ad request 112, to programmatically create videos based on rules from an advertiser, using existing pool of content or generating new content.

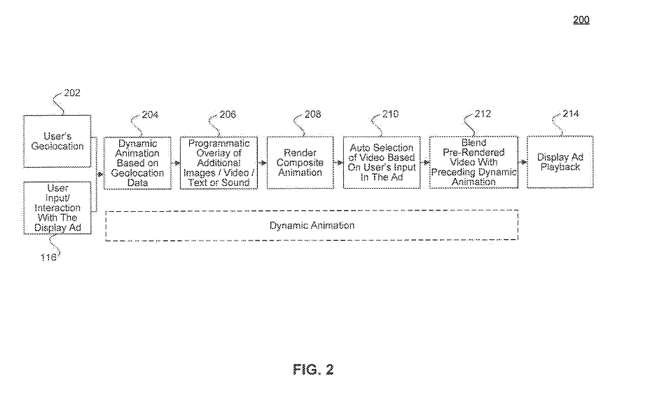

FIG. 2 is a method 200 for dynamically generating video/animation, in real-time, in a display or electronic advertisement based on user data, according to an embodiment. The method 200 illustrates a general diagram of various components or stages that may go into generating an exemplary video/animation in real time. In one embodiment, the system may learn a user's geolocation 202 and/or receive user input or interactions 116. Geolocation 202 is only one example of information about a user that may be used to dynamically generate advertisements for presentation to the user. As mentioned above, user input 116 may be any information provided by the user before or during the playback of advertisement 104.

At stage 204, a dynamic animation may be generated based on geolocation data 202. For example, ad serving system 102 may provide geolocation data 202 to a web service, and receive back (in real-time) a generated dynamic animation for display.

At stage 206, ad serving system 102 may perform a programmatic overlay of additional images/video, text, or sound. For example, while a video is playing, such as dynamic animation generated at stage 204, ad serving system 102 may generate additional video or may overlay portions of the video with information pertaining to the user. For example, if advertisement 104 includes an image of a computer screen, ad serving system 102 may overlay the computer screen in advertisement 104 with a website being viewed by the user. At stage 208, ad serving system 102 may render the composite of the existing video with the overlaid video.

A portion of advertisement 104 may play and may request additional input/feedback from the user. At stage 210, ad serving system 102 may automatically select additional video to be generated or rendered for a user in the advertisement based on the additional user feedback or user input 116. The automatic generation may occur without any additional input from a system administrator, and may automatically select which additional video to play or generate based on the user input 116. At stage 212, ad serving system 102 may blend the pre-rendered video with the existing or playing advertisement. At stage 214, the remainder of display ad 104 may be played for the user. As shown in. FIG. 2, stages 204, 206, 208, 210, and 212 may all include dynamic animation (e.g., dynamic ad components 124) which may be selected or generated in real time.

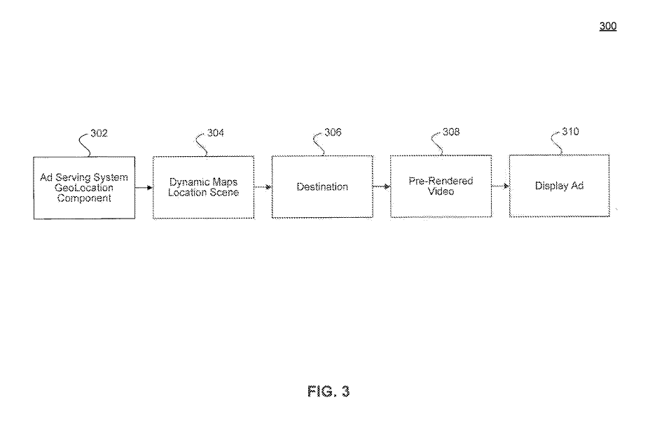

FIG. 3 is a block diagram 300 that illustrates components that may go into generating an exemplary video/animation in real time, according to an embodiment.

Ad serving system 102 may include a geolocation component 302 that determines a user's location for each ad impression. A dynamic maps location scene 304 may be generated. For example, an animation received from a mapping system, using the mapping system's satellite images, may be used as dynamic maps location scene 304. Dynamic maps location scene may include a zooming out from the ground at the user's location into the sky.

The user may then provide a selected or desired destination 306. Ad serving system 102 may then programmatically overlay a pre-rendered ribbon or other icon in the video for this animation, and add a cloud scene video that reaches the provided destination 306. Ad serving system 102 may also select a pre-rendered video 308 for inclusion with advertisement 104, such as a tag line or call to action. The composited video with images from the maps are then provided as a full display ad 310.

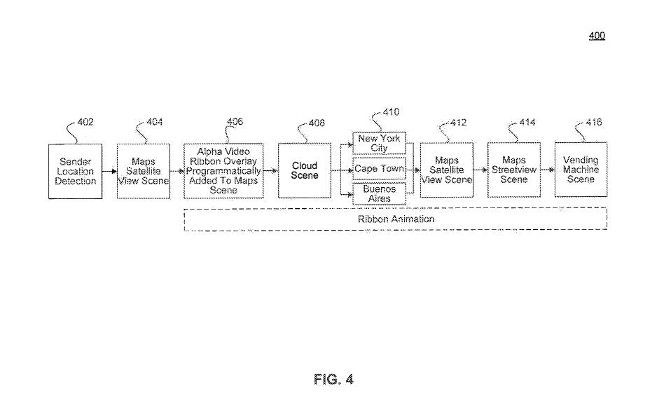

FIG. 4 illustrates an example embodiment 400 of using the method 200 of FIG. 2. The example embodiment 400 is directed to an advertisement for display on a vending machine.

At stage 402, ad serving system 102 may detect the location of a sender. For example, the embodiment 400 may allow a sender to send a product, such as soda, to a particular vending machine. The sender may for example, type a message that is sent with the product or via the advertisement.

At stage 404, ad serving system 102 may generate map imagery based on the location of the sender. In an embodiment, ad serving system 102 may contact another web service, provide the location of the sender, and retrieve the video as generated by the web service.

At stage 406, ad serving system 102 may then overlay the dynamically generated maps scene (404) with an image or animation. For example, a ribbon may be overlaid on the maps scene and presented to the user.

At stage 408, ad serving system 102 may then integrate or blend a cloud scene with the overlaid image. For example, the overlaid image may lead into the cloud scene. In an embodiment, the cloud scene may have been pre-rendered and integrated with the dynamically generated ribbon overlay added to the maps scene (406).

At stage 410, ad serving system 102 may prompt the sender for input. For example, the sender may be prompted to select a location where the sender wants to send the product or message. In the example, the user may select New York City, Cape Town or Buenos Aires, each of which may correspond to a location of where a vending machine that is capable of receiving or displaying the advertisement is located. At stages 412 and 414, based on the selection (410), an additional or new video of a map may be generated and provided into the advertisement after the user selection. The maps satellite scene (412) may be blended, in real-time, into the the cloud scene (408) and may end in the a street view scene (414) including the selected location (410). Similar to stage 404, stages 412 and 414 may include images or animations as generated in real time by ad serving system 102 or another web service that is provided the selected location (410). At stage 416, the street view (414) may be blended into a pre-rendered animation or image of a vending machine receiving the message or advertisement. As shown in FIG. 4, each of stages 406-416 may include an overlay of a ribbon animation.

In this example, each user may see a video tailored, in real-time, to their location, experience and interaction with the advertisement. In the example of FIG. 4, the entire interaction may be occur at a vending machine, where the advertisement is being shown. Example, cues that may be used in the advertisement may include geographical or location data, the age, gender, interests and potential third party data, such as websites the user has visited.

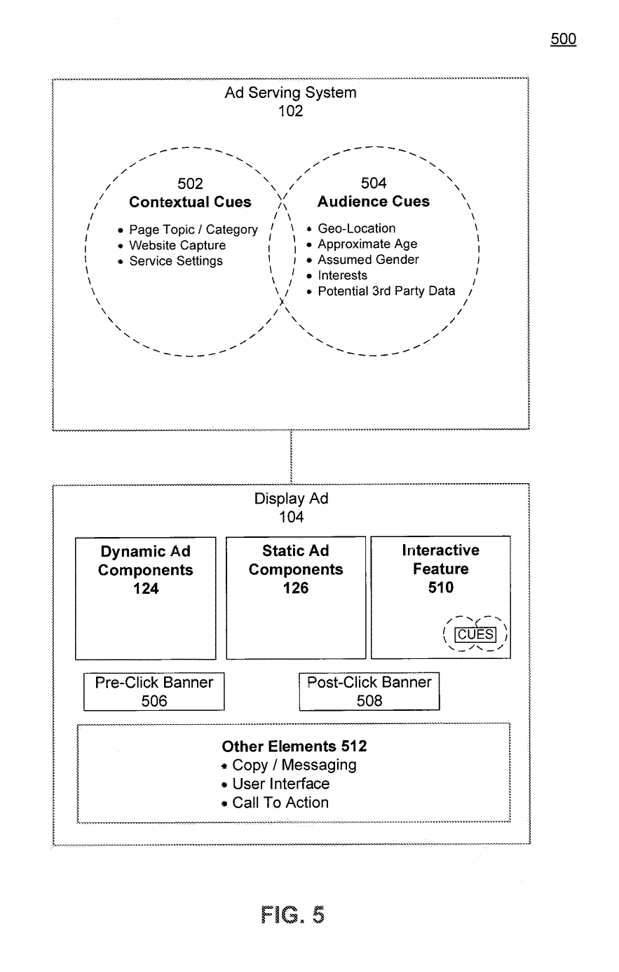

FIG. 5 is a diagram 500 illustrating an example usage of a system for dynamically generating a display or electronic advertisement based on user data, according to an embodiment.

Ad serving system 102 may get or receive contextual cues 502 and/or audience cues 504 from which to generate a video or display ad 104. Contextual cues 502 may include device settings (e.g., device settings 118), such as information about a page topic or website or webpage 108. Audience cues 504 may include any information queried from a user who is viewing or otherwise accessing advertisement 104 (e.g., user input 116). Contextual cues 502 and audience cues 504 may be provided as part of ad request 112, or may be gathered by advertisement 104 during operation. FIG. 5 shows exemplary contextual cues 502 and audience cues 504.

Display ad 104 may include dynamically generated content (dynamic ad components 124) and static ad components 126. Components 124, 126 may be displayed on a pre-click banner 506, a post-click banner 508, and/or may be coupled with an interactive feature 510. Pre-click banner 506 may include that portion of advertisement 104 that is generated based on ad request 112 (e.g., prior to or without requesting additional input by a user who is viewing advertisement 104). Pre-click banner 506 may be, for example, a credits-style opening, a montage of character setup, or location-specific scenery and road signs. Or, for example, pre-click banner 506 may be a trailer or teaser, a recap of a story-line, or simply a portion of advertisement 104.

Post-click banner 508 may include that portion of advertisement 104 that is generated based on additional user information (e.g., user input 116) provided after advertisement 104 has begun running on browser 110. A user may provide user input 116 as audience cues 504 that is used by ad serving system 102 to generate a portion of post-click banner 508. User input 115 may include keyboard or mouse clicks, video/images, audio or other input.

In an embodiment, pre-click banner 506 may incorporate dynamic cues 502, 504 to make the pre-click experience more relevant to a user or viewer. For example, incorporating information about the user's device settings 118 or environment into pre-click banner 506 may make a user more likely to pay attention and click advertisement 104. Similarly, post-click banners 508 that include information relative to the audience or viewers, based on dynamic variables determined about the users' environments may make advertisement 104 more relevant to the viewers.

As shown, display ad 104 may also include an interactive feature 510. Interactive feature 510, as discussed above, may be a portion of display ad 104 that interacts with or reacts to user input 116 or device settings 118, that may be received in response to one or more cues 502, 504. Display ad 104 may also include other elements 512 including, but not limited to, copying or messaging, a user interface, and a call to action.

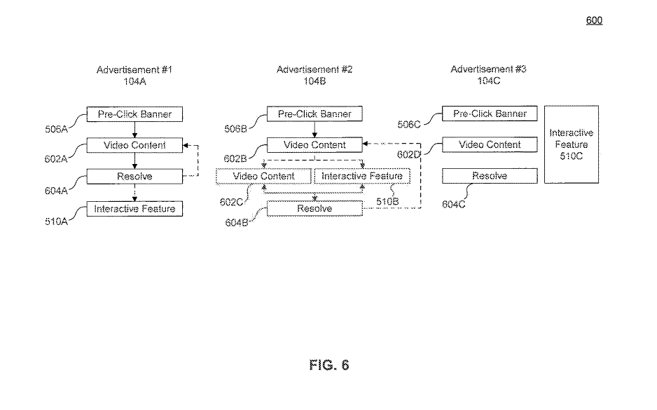

FIG. 6, shows example advertisements 104A-C that may be generated by ad serving system 102. Each advertisement 104 may include a pre-click banner portion 506A-C that is displayed. Pre-click banner 506 may be an introduction, graphic, or other portion of an advertisement 104 that is rendered on a webpage. Pre-click banner 506 may include contextual cues 502 about the user's environment (e.g., as received with ad request 112).

In advertisement #1 (104A), pre-click banner 506A may be followed by video content 602A. Advertisement 104A may also include resolve 604A at which point cues 502, 504 may be resolved. Using information received from resolve 604A, additional video content 602A may be displayed or an interactive feature 510A may be rendered. As mentioned above, during interactive feature 510A, advertisement 104 may react to information provided by or queried from the user who makes a selection or provides information.

In advertisement #2 (104B), following pre-click banner 506B, video content 602B may be rendered. Advertisement 104B may or may not have an interactive feature 510B that is provided in the middle of the advertisement 104B, in which responses to the interactive feature 510B may resolved 604B and which may result in additional video content 602B, 602C or interactive feature 510B. For example, advertisement 104B may include a game that a user plays until the user beats, which results in repeated display of interactive feature 510B, resolve 604B and video content 602B. Then, when the game is beaten by the user, advertisement 104B may render video content 602C.

Advertisement #3 (104C) may include pre-click banner 506C, video content 602D, and resolve 604C. Interactive features 510C that may be included or incorporated within advertisement 104C whenever a response to cue 502, 504 is received from a user. For example, advertisement 104C may include an image of a screen that will change whenever a user or viewer of advertisement 104C texts a message into a number shown on the screen.

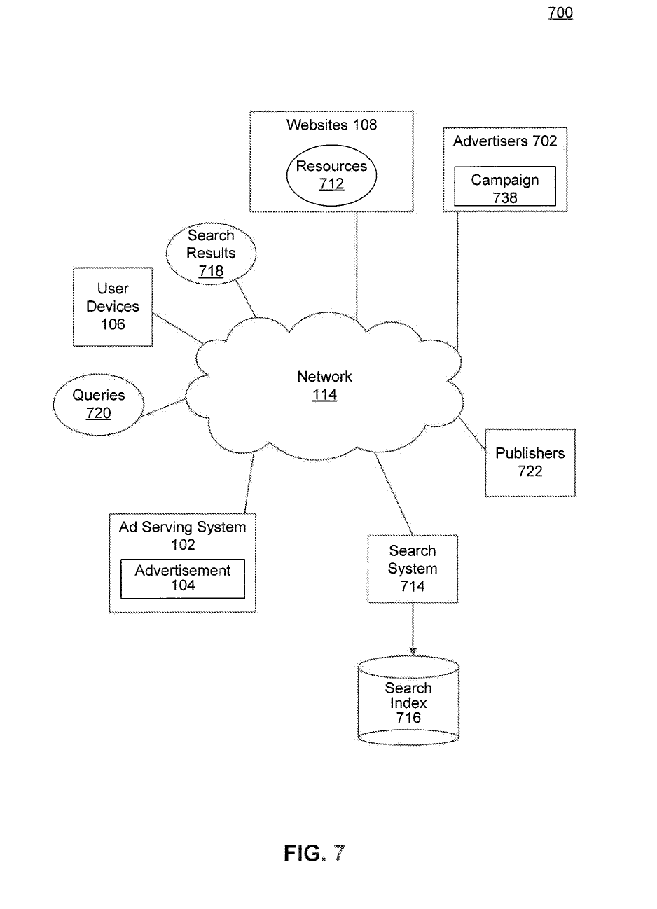

FIG. 7 is a block diagram 700 of an example environment in which an advertisement system manages advertising services, according to an embodiment. One or more networks 114 such as a local area network (LAN), a wide area network (WAN), the Internet, or a combination thereof may provide communication amongst the component shown in FIG. 7. Network 114 connects user devices 106, websites 108, advertisers 702 promoting various campaigns 738, and ad serving system 102. In an embodiment, thousands of user devices 106106, websites 108, and advertisers 702 may be connected via network 114.

Website 108 may include one or more resources 712 associated with a domain name and hosted by one or more servers. An example website 108 is a collection of webpages formatted in hypertext markup language (HTML) that can contain text, images, multimedia content, and programming elements, such as scripts. Each website 108 is maintained by a publisher 722, which is an entity that controls, manages and/or owns the website. In an example embodiment, publisher 722 and advertiser 702 may be the same or different entities.

A resource 712 is any data that can be provided over the network 704. A resource 712 is identified by a resource address that is associated with the resource 712. Resources 712 include HTML pages, word processing documents, and portable document format (PDF) documents, images, video, and feed sources, to name only a few. Resources 712 can include content, such as words, phrases, images and sounds, that may include embedded information (such as meta-information in hyperlinks) and/or embedded instructions (such as JavaScript scripts).

User device 106 is an electronic device that is under control of a user and is capable of requesting and receiving resources over the network 114. Example user devices 106 include personal computers, mobile communication devices, and other devices that can send and receive data over the network 114. A user device 106 typically includes a user application, such as a web browser (e.g., browser 110), to facilitate the sending and receiving of data over the network 114. User devices 106, such as mobile communication devices, may also include other user applications, such as text message applications, gaming applications, news applications, book and magazine reader applications, and other applications provided by publishers 722. Applications provided by publishers 722 may also be known as resources 712.

User device 106 can request resources 712 from website 108. In turn, data representing the resource 712 can be provided to the user device 106 for presentation by user device 106. The data representing the resource 712 can also include data specifying a portion of the resource or a portion of a user display (e.g., a presentation location of a pop-up window or in a slot of a webpage) in which advertisements 104, can be presented and selected. These specified portions of the resource or user display are referred to as advertisement slots.

To facilitate searching of these resources, environment 700 may include a search system 714 that identifies the resources by crawling and indexing the resources provided by the publishers on the websites. Data about the resources can be indexed based on the resource to which the data corresponds. The indexed and, optionally, cached copies of the resources are stored in an indexed cache 716.

User devices 106 can submit search queries 720 to the search system 714 over the network 114. In response, the search system 714 accesses the indexed cache 716 to identify resources that are relevant to the search query 720. The search system 714 identifies the resources in the form of search results 718 and returns the search results 718 to user devices 106 in search results pages. A search result 718 is data generated by the search system 714 that identifies a resource that is responsive to a particular search query, and includes a link to the resource. An example search result 718 can include a webpage title, a snippet of text or a portion of an image extracted from the webpage, and the URL of the webpage. Search results pages can also include one or more advertisement slots in which advertisements 104 can be presented.

When resource 712 provided by a publisher 722 or search results 718 is requested by user device 106, ad serving system 102 receives a request (e.g., ad request 112), from a publisher 722 or advertiser, for advertisements 104 to be provided with the resource 712 or search results 718. Ad request 112 for advertisements 104 can include characteristics of the advertisement slots, such as keywords, that are defined for the requested resource or search results page, and can be provided to the ad serving system 102.

For example, a reference (e.g., URL) to the resource for which the advertisement slot is defined, a size of the advertisement slot, and/or media types that are available for presentation in the advertisement slot can be provided to the advertisement system for use in selecting which advertisement(s) to include with the requested resource. Similarly, keywords associated with a requested resource (“resource keywords”) or a search query 720 for which search results are requested can also be provided to advertisement system to facilitate identification of advertisements that are relevant to the resource or search query 720. Further, images and multimedia elements that are associated with the resource may be provided to advertisement system.

Based on data included in ad request 112, ad serving system 102 can select advertisements 104 that are eligible to be provided in response to the request (“eligible advertisements”). For example, eligible advertisements can include advertisements 104 having characteristics matching the characteristics of advertisement slots and that are identified as relevant to specified resource keywords or search queries 720. In some implementations, advertisements having targeting keywords that match the resource keywords or the search query 720 are selected as eligible advertisements by the ad serving system 102. As described with respect to embodiments, advertisements 104 associated with advertisement images with features matching images associated with a resource or webpage may be selected as eligible advertisements by ad serving system 102.

A targeting keyword can match a resource keyword or a search query 720 by having the same textual content (“text”) as the resource keyword or search query 720. For example, advertisement 104 associated with the targeting keyword “daisy” can be an eligible advertisement for an advertisement request including the resource keyword “daisy.” Similarly, the advertisement 104 can be selected as an eligible advertisement for an ad request 112 including the search query “daisy.”

A targeting keyword can also match a resource keyword or a search query 720 by having text that is identified as being relevant to a targeting keyword or search query 720 despite having different text than the targeting keyword. For example, advertisement 104 having the targeting keyword “daisy” may also be selected as an eligible advertisement for an ad request 112 including a resource keyword or search query for “flowers” because daisy is a type of flower, and therefore, is likely to be relevant to the term “flowers.”

Similarly, a user may search for audio content or video content by entering a search query 720 including one or more keywords. For example, the user may enter the search query “sports car” and be presented with a selection of one or more videos of sports cars or race cars. Upon selecting a video, the video may then be associated with the search query term “sports car” as the text label for that video. The video may be provided as part of a publisher webpage. Accordingly, ad serving system 102 may use this text label to identify relevant advertisements in response to ad request 112.

Ad serving system 102 can select the eligible advertisements that are provided for presentation in advertisement slots of a resource based on results of an auction. For example, the ad serving system 102 can receive bids from advertisers 702 and allocate the advertisement slots to the highest bidders at the conclusion of the auction. The bids are amounts that advertisers 702 are willing to pay for presentation (or selection) of their advertisement with a resource or search results page. For example, a bid can specify an amount that advertiser 702 is willing to pay for each 1000 impressions (i.e., presentations) of the advertisement, referred to as a CPM bid. Alternatively, the bid can specify an amount that advertiser 702 is willing to pay for a selection (i.e., a click-through) of the advertisement or a “conversion” following selection of the advertisement. The highest bidders can be determined based on the bids alone, or based on the bids of each bidder being multiplied by one or more factors, such as quality scores derived from advertisement performance, landing page scores, and the like.

Advertisers 702 can also specify budgets for their advertisement campaigns 138. A budget is a specified amount that advertiser 702 is willing to pay for distribution of content over a specified budget period. The specified period can be, for example, a specified time (e.g., one day, one week, or one year), a specified number of events (e.g., a number of impressions or clicks), or some other delineation of time or events. Once the amount advertiser 702 is charged for distribution of content during the budget period matches or exceeds the budget amount, the campaign can be prevented from providing content for the remainder of the budget period unless advertiser 702 increases or overrides its specified budget.

Ad serving system 102 may be implemented in software, firmware, hardware or any combination thereof on one or more computing devices. For example, ad serving system 102 may be part of or may be implemented with a computing device, such as, a processor-based computing device. A computing device can be any type of device having one or more processors. For example, a computing device can be a workstation, mobile device (e.g., a mobile phone, personal digital assistant, tablet or laptop), computer, server, compute cluster, server farm, game console, set-top box, kiosk, embedded system or other device having at least one processor and memory. Embodiments may be software executed by a processor, firmware, hardware or any combination thereof in a computing device.

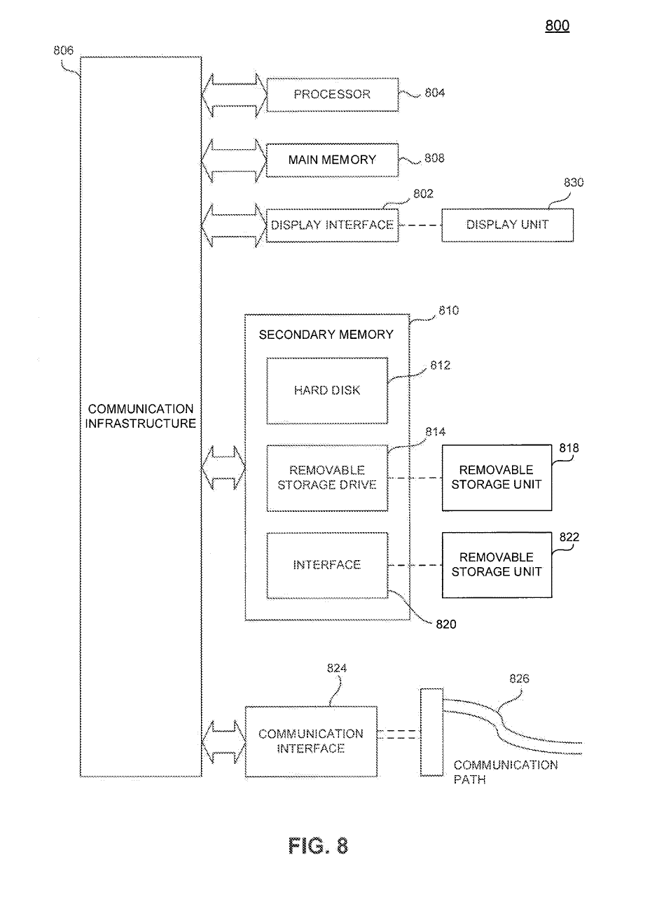

FIG. 8 illustrates an example computer system 800 in which embodiments of as described herein, or portions thereof, may by implemented as computer-readable code. For example, ad serving system 102 may be implemented in computer system 800 using hardware, software, firmware, tangible computer readable media having instructions stored thereon, or a combination thereof and may be implemented in one or more computer systems or other processing systems. Hardware, software, or any combination of such may embody any of the modules, procedures and components FIGS. 1-7.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, a computing device having at least one processor device and a memory may be used to implement the above-described embodiments. A processor device may be a single processor, a plurality of processors, or combinations thereof. Processor devices may have one or more processor “cores.”

Various embodiments are described in terns of this example computer system 800. After reading this description, it will become apparent to a person skilled in the relevant art how to implement the embodiments using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general-purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 is connected to a communication infrastructure 806, for example, a bus, message queue, network, or multi-core message-passing scheme.

Computer system 800 also includes a main memory 808, for example, random access memory (RAM), and may also include a secondary memory 810. Secondary memory 810 may include, for example, a hard disk drive 812, removable storage drive 814. Removable storage drive 814 may comprise a floppy disk drive, a magnetic tape drive, an optical disk drive, a flash memory, or the like. The removable storage drive 814 reads from and/or writes to a removable storage unit 818 in a well-known manner. Removable storage unit 818 may comprise a floppy disk, magnetic tape, optical disk, etc. which is read by and written to by removable storage drive 814. As will be appreciated by persons skilled in the relevant art, removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card, or the like. Communications interface 824 via a communications path 826 may provide communications and may be implemented using wire or cable, fiber optics, a phone line, a cellular phone link, an RF link or other communications channels.

In this document, the Willis “computer program medium” and “computer usable medium” are used to generally refer to media such as removable storage unit 818, removable storage unit 822, and a hard disk installed in hard disk drive 812. Computer program medium and computer usable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement the present embodiments as discussed herein. In particular, the computer programs, when executed, enable processor device 804 to implement the processes as illustrated by the flowcharts of FIGS. 3 and 4 discussed above. Accordingly, such computer programs represent controllers of the computer system 800. Where an embodiment is implemented using software, the software may be stored in a computer program product and loaded into computer system $00 using removable storage drive 814, interface 820, and hard disk drive 812, or communications interface 824.

Embodiments may also be directed to computer program products comprising software stored on any computer useable medium. Such software, When executed in one or more data processing device, causes a data processing device(s) to operate as described herein. Embodiments may employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments allows others, by applying knowledge within the skill of the art, readily modify and/or adapt or various applications such specific embodiments, without undue experimentation, without departing from the general concept of what has been described herein. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A computer-implemented method comprising:
providing, from a server comprising one or more processors, to a user device, a first portion of an advertisement for display on the user device, the first portion including a pre-rendered video scene and an interactive component;
determining, by an input processor executed by the one or more computing processors of the server, without requiring user interaction with the user device, a characteristic associated with the user device;
generating, by an ad generator executed by the one or more computing processors of the server, a second portion of the advertisement based on the determined characteristic, the second portion including a second video scene for presentation subsequent to the pre-rendered video scene;
receiving, from the user device, input information from an interaction with the interactive component;
generating, by the ad generator, a third portion of the advertisement responsive to the received input information, the third portion including a third video scene for presentation subsequent to the pre-rendered video scene;
providing the second portion of the advertisement and the third portion of the advertisement to the user device for display; and
dynamically rendering, by the ad generator while providing an earlier portion of the advertisement, a portion of at least one of the second video scene and the third video scene based on data received from the user device.

2. The computer-implemented method of claim 1, wherein the characteristic of the user device identifies an approximate geographical location of the user device.

3. The computer-implemented method of claim 1, wherein the characteristic of the user device identifies an interest.

4. (canceled)

5. The computer-implemented method of claim 2, wherein the characteristic of the user device identifies a weather condition of the approximate geographical location.

6. The computer-implemented method of claim 2, wherein the characteristic of the user device identifies a time of day associated with the approximate geographical location.

7-13. (canceled)

14. A system comprising:
a server comprising a computing processor and a network interface, the computing processor configured to execute an input processor and an ad generator;
wherein the network interface is configured to:
receive a request from a user device,
provide, to the user device responsive to the request, a first portion of an advertisement for display on the user device, the first portion including a pre-rendered video scene and an interactive component;
wherein the input processor is configured to:
determine, without requiring user interaction with the user device, a characteristic associated with the user device;
wherein the ad generator is configured to:
generate a second portion of the advertisement based on the determined characteristic, the second portion including a second video scene for presentation subsequent to the pre-rendered video scene;
receive, from the user device, input information from an interaction with the interactive component;
generate a third portion of the advertisement responsive to the received input information, the third portion including a third video scene for presentation subsequent to the pre-rendered video scene; and
provide the second portion of the advertisement and the third portion of the advertisement to the user device for display;
wherein the ad generator is further configured to dynamically render, while providing an earlier portion of the advertisement, a portion of at least one of the second video scene and the third video scene based on data received from the user device.

15. The system of claim 14, wherein the characteristic of the user device identifies an approximate geographical location of the user device.

16. The system of claim 14, wherein the characteristic of the user device identifies an interest.

17. (canceled)

18. The system of claim 15, wherein the characteristic of the user device identifies a weather condition of the approximate geographical location.

19. The system of claim 15, wherein the characteristic of the user device identifies a time of day associated with the approximate geographical location.

20. A computer program product comprising non-transitory memory storing instructions that, when executed by a server comprising one or more processors, cause the one or more processors to:
provide, from the server to a user device, a first portion of an advertisement for display on the user device, the first portion including a pre-rendered video scene and an interactive component;
determine, by an input processor of the server, without requiring user interaction with the user device, a characteristic associated with the user device;
generate, by an ad generator of the server, a second portion of the advertisement based on the determined characteristic, the second portion including a second video scene for presentation subsequent to the pre-rendered video scene;
receive, from the user device, input information from an interaction with the interactive component;
generate, by the ad generator of the server, a third portion of the advertisement responsive to the received input information, the third portion including a third video scene for presentation subsequent to the pre-rendered video scene; and
provide the second portion of the advertisement and the third portion of the advertisement to the user device for display;
wherein the server is configured to dynamically render, while providing an earlier portion of the advertisement, a portion of at least one of the second video scene and the third video scene based on data received from the user device.

21.-22. (canceled)

23. The computer program product of claim 20, wherein the characteristic of the user device identifies an approximate geographical location of the user device.

24. The computer program product of claim 23, wherein the characteristic of the user device identifies a weather condition of the approximate geographical location.

25. The computer program product of claim 23, wherein the characteristic of the user device identifies a time of day associated with the approximate geographical location.

26. The computer-implemented method of claim 1, comprising:
rendering, by the server, the second video scene responsive to receiving the characteristic associated with the user device; and
rendering, by the server, the third video scene responsive to receiving the input information.

27. The computer-implemented method of claim 1, wherein the advertisement includes a live broadcast element.

28. The system of claim 14, the computer-readable memory storing instructions that, when executed by the one or more processors, cause the one or more processors to:
render the second video scene responsive to receiving the characteristic associated with the user device; and
render the third video scene responsive to receiving the input information.

29. The system of claim 14, wherein the advertisement includes a live broadcast element.

30. The computer program product of claim 20, the non-transitory memory storing instructions that, when executed by the one or more processors, cause the one or more processors to:
render the second video scene responsive to receiving the characteristic associated with the user device; and
render the third video scene responsive to receiving the input information.

31. The computer program product of claim 20, wherein the advertisement includes a live broadcast element.
